(19) United States
(12) Patent Application Publication
(10) Pub. No.: US 2026/0111161 A1
(43) Pub. Date: Apr. 23, 2026

(54) ARITHMETIC PROCESSING DEVICE, IMAGING DEVICE AND HEAD MOUNTED SYSTEM

(71) Applicant: ASUSTeK COMPUTER INC., Taipei City (TW)

(72) Inventor: Jyun-Miao Hong, Taipei City (TW)

(73) Assignee: ASUSTeK COMPUTER INC., Taipei City (TW)

(21) Appl. No.: 19/046,378

(22) Filed: Feb. 5, 2025

(30) Foreign Application Priority Data
Oct. 18, 2024 (TW) 113139654

(51) Int. Cl. G06F 3/14; G06F 1/16

(52) U.S. Cl. CPC G06F 3/14; G06F 1/163

(57) ABSTRACT

An arithmetic processing device, an imaging device, and a head mounted system are provided. The arithmetic processing device includes a first circuit board, a processor, and a first modulation circuit. The first circuit board has a first transmission interface. The processor is mounted on the first circuit board and configured to evaluate transmission quality of a transmission signal transmitted through the first transmission interface. The first modulation circuit is mounted on the first circuit board and coupled between the processor and the first transmission interface. The processor transmits a first control signal to the first modulation circuit according to the evaluated transmission quality of the transmission signal, so as to switch a modulation mode of the transmission signal performed by the first modulation circuit.

### CROSS-REFERENCE TO RELATED APPLICATION

This application claims the priority benefit of Taiwan application serial no. 113139654, filed on Oct. 18, 2024. The entirety of the above-mentioned patent application is hereby incorporated by reference herein and made a part of this specification.

### BACKGROUND

### Technical Field

The disclosure relates to an arithmetic processing device, an imaging device, and a head mounted system that may provide users with a better use experience.

### Description of Related Art

As technology advances with each passing day, people's ways of absorbing information are also increasing. In order to take into account the requirements of visual effects and portability, head mounted display (HMD) has been launched on the market. However, the head mounted displays on the market all integrate various components such as mainboards, batteries, screens, processors, etc., all of which are configured on the same hardware structure. As a result, excessive weight is placed on the user's head, making it impossible to use the head mounted display for a long time and causing shoulder and neck pain, which in turn affects the use experience.

### SUMMARY

The disclosure provides an arithmetic processing device, which includes a first circuit board, a processor, and a first modulation circuit. The first circuit board has a first transmission interface. The processor is mounted on the first circuit board and configured to evaluate transmission quality of a transmission signal transmitted through the first transmission interface. The first modulation circuit is mounted on the first circuit board and coupled between the processor and the first transmission interface. The processor transmits a first control signal to the first modulation circuit according to the evaluated transmission quality of the transmission signal, so as to switch a modulation mode of the transmission signal performed by the first modulation circuit.

The disclosure also provides an imaging device, which includes an image display device, an image capture device, a second circuit board, a controller, and a second modulation circuit. The second circuit board has a second transmission interface. The controller is mounted on the second circuit board and coupled to the image display device and the image capture device, and is configured to evaluate transmission quality of a transmission signal transmitted through the second transmission interface. The second modulation circuit is mounted on the second circuit board and coupled between the controller and the second transmission interface. The controller transmits a second control signal to the second modulation circuit according to the evaluated transmission quality of the transmission signal, so as to switch a modulation mode of the transmission signal performed by the second modulation circuit.

The disclosure also provides a head mounted system, which includes an arithmetic processing device and an imaging device. The arithmetic processing device includes a first circuit board, a processor, and a first modulation circuit. The first circuit board has a first transmission interface. The processor is mounted on the first circuit board and configured to evaluate transmission quality of a transmission signal transmitted through the first transmission interface. The first modulation circuit is mounted on the first circuit board and coupled between the processor and the first transmission interface. The imaging device includes an image display device, an image capture device, a second circuit board, a controller, and a second modulation circuit. The second circuit board has a second transmission interface. The second transmission interface and the first transmission interface are detachably connected to each other through a cable. The controller is mounted on the second circuit board and coupled to the image display device and the image capture device, and is configured to evaluate transmission quality of a transmission signal transmitted through the second transmission interface. The second modulation circuit is mounted on the second circuit board and coupled between the controller and the second transmission interface. The processor and the controller work together to complete an evaluation of the transmission quality of the transmission signal transmitted through the first transmission interface and the second transmission interface, so as to respectively switch a modulation mode of the transmission signal performed by the first modulation circuit and the second modulation circuit.

Based on the above, the arithmetic processing device, imaging device and head mounted system of the disclosure may independently configure various components required for the head mounted display on different hardware structures, and may dynamically switch the modulation mode of the transmission signal. In this way, the weight originally placed on the user's head may be reduced and good transmission quality may be maintained between hardware structures. Not only can it extend the use time and avoid shoulder and neck pain, but it can also adapt to cables of different lengths or styles, thus giving the user a better use experience.

In order to make the above-mentioned features and advantages of the disclosure clearer and easier to understand, the following embodiments are given and described in details with accompanying drawings as follows.

### BRIEF DESCRIPTION OF THE DRAWINGS

FIG. 1 is a schematic block diagram of an arithmetic processing device according to an embodiment of the disclosure.

FIG. 2 is a schematic circuit diagram of a first modulation circuit according to an embodiment of the disclosure.

FIG. 3 is a schematic block diagram of an imaging device according to an embodiment of the disclosure.

FIG. 4 is a schematic circuit diagram of a second modulation circuit according to an embodiment of the disclosure.

FIG. 5A is a schematic diagram illustrating a product of a head mounted system according to an embodiment of the disclosure.

FIG. 5B is a schematic block diagram of a head mounted system according to an embodiment of the disclosure.

### DESCRIPTION OF THE EMBODIMENTS

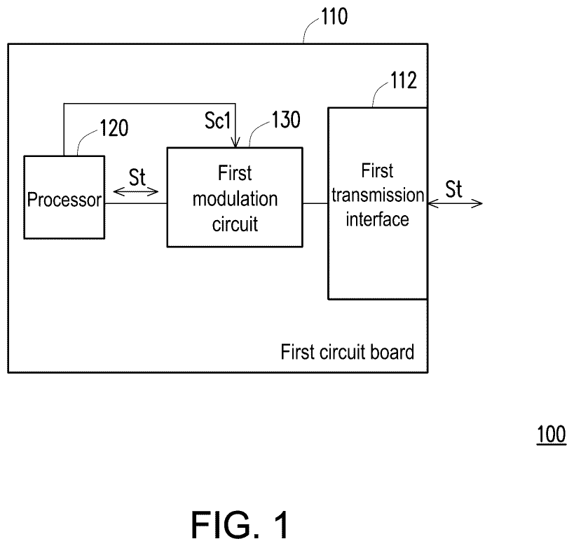

Referring to FIG. 1, an arithmetic processing device 100 of the embodiment includes a first circuit board 110, a processor 120, and a first modulation circuit 130. The first circuit board 110 is implemented by, for example, a printed circuit board (PCB). The first circuit board 110 has a first transmission interface 112, which may transmit signals with external devices through connected cables.

The processor 120 is, for example, a central processing unit (CPU) or other programmable general-purpose or special-purpose microprocessors, a digital signal processor (DSP), a programmable controller, an application specific integrated circuit (ASIC), or other similar elements, or a combination thereof. The processor 120 is mounted on the first circuit board 110 and may evaluate the transmission quality of a transmission signal St transmitted (including output or reception) through the first transmission interface 112.

The first modulation circuit 130 is mounted on the first circuit board 110 and coupled between the processor 120 and the first transmission interface 112.

In the example, the processor 120 may transmit a first control signal Sc1 to the first modulation circuit 130 according to the evaluated transmission quality of the transmission signal St, so as to switch the modulation mode of the transmission signal St performed by the first modulation circuit 130. For example, when the first control signal Sc1 is at a first logic level (e.g., a high logic level), the first modulation circuit 130 re-drives the transmission signal St. When the first control signal Sc1 is at the second logic level (e.g., a low logic level), the first modulation circuit 130 performs parallel-to-serial conversion on the transmission signal St.

Furthermore, the transmission quality of the transmission signal St includes the transmission signal amount of the transmission signal St. The processor 120 may evaluate the transmission signal amount of the transmission signal St output to or received from the outside through the first transmission interface 112. In the embodiment, the initial value of the first control signal Sc1 output by the processor 120 is the first logic level. That is to say, the first modulation circuit 130 first modulates the transmission signal St in a re-driving mode to reshape the transmission signal St. In addition to increasing the gain, the waveform may also be restored as much as possible.

When the processor 120 evaluates that the transmission signal amount of the redriven transmission signal St is less than a first threshold percentage (e.g., about sixty percent), it means that even if re-driving has been performed, the transmission signal St is still attenuated too much after transmission, and the waveform becomes incomplete, possibly because the cable used for signal transmission with an external device is long or is subject to external electromagnetic wave interference. At this time, the processor 120 may transmit the first control signal Sc1 of the second logic level to the first modulation circuit 130, so as to control the first modulation circuit 130 to perform parallel-to-serial conversion on the transmission signal St. In this way, the first modulation circuit 130 may modulate the transmission signal St in a parallel-to-serial conversion mode. When outputting the transmission signal St to an external device, the first modulation circuit 130 may convert the transmission signal St into an ultra-high-speed serial form for transmission on the cable. When receiving the transmission signal St from an external device, the first modulation circuit 130 may convert the transmission signal St from an ultra-high-speed serial form to an original form (e.g., a parallel form). In this way, the data processing capacity of the signal per unit time may be increased, and the signal is less susceptible to external interference when transmitted through cables, thus improving the transmission quality.

On the other hand, when the processor 120 evaluates that the transmission signal amount of the transmission signal St is at or above the first threshold percentage, it means that the current transmission signal St still meets the transmission standard. At this time, the processor 120 may continue to transmit the first control signal Sc1 of the first logic level to the first modulation circuit 130, so that the first modulation circuit 130 continues to re-drive the transmission signal St.

Furthermore, in an embodiment, when the data rate of the redriven transmission signal St is more than the second threshold percentage (e.g., about 80 percent), it means that the demand for data processing capacity is higher. At this time, the processor 120 may also switch from the re-driving mode to the parallel-to-serial conversion mode to modulate the transmission signal St, so as to increase the data processing capacity of the signal per unit time.

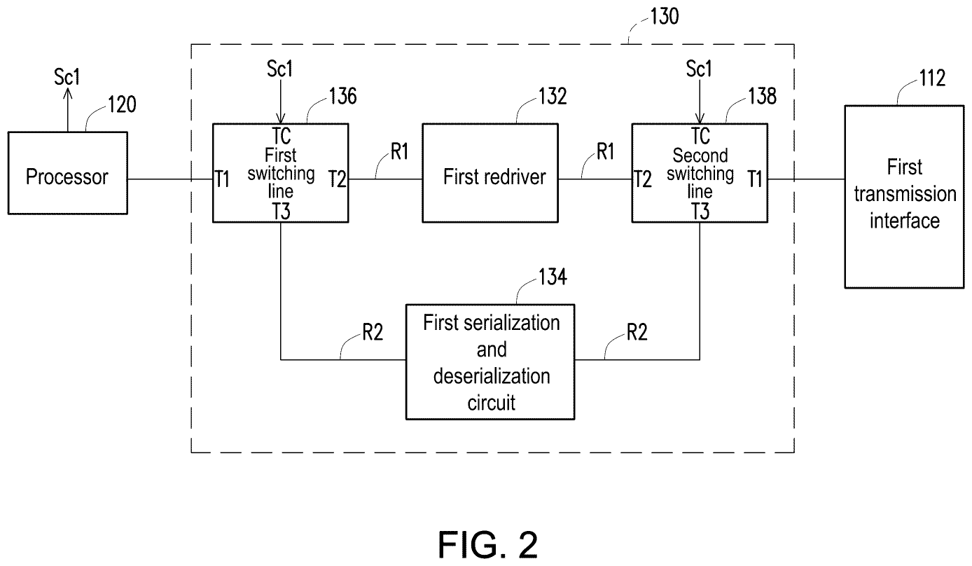

The following examples illustrate the implementation details of the first modulation circuit 130. Referring to FIG. 2, the first modulation circuit 130 includes a first transmission path R1, a second transmission path R2, a first redriver 132, a first serialization and deserialization circuit 134, a first switching line 136, and a second switching line 138.

The first redriver 132 is located on the first transmission path R1 and may re-drive the transmission signal St transmitted on the first transmission path R1.

The first serialization and deserialization circuit 134 is implemented, for example, as a combination of a serializer and a de-serializer. The first serialization and deserialization circuit 134 is located on the second transmission path R2 and may perform parallel-to-serial conversion on the transmission signal St transmitted on the second transmission path R2. For example, when receiving the transmission signal St from the processor 120 side, the first serialization and deserialization circuit 134 may convert the transmission signal St into an ultra-high-speed serial form through the function of the serializer and provide the same to the first transmission interface 112. When receiving the transmission signal St from the first transmission interface 112 side, the first serialization and deserialization circuit 134 may convert the transmission signal St from an ultra-high-speed serial form to an original form (e.g., a parallel form) through the function of the de-serializer.

The first switching line 136 is coupled to the processor 120, one end of the first transmission path R1, and one end of the second transmission path R2. The first switching line 136 may be controlled by the first control signal Sc1 such that the processor 120 is caused to switch between being coupled to the first transmission path R1 and being coupled to the second transmission path R2.

The second switching line 138 is coupled to the first transmission interface 112, the other end of the first transmission path R1, and the other end of the second transmission path R2. The second switching line 138 may be controlled by the first control signal Sc1 such that the first transmission interface 112 is caused to switch between being coupled to the first transmission path R1 and being coupled to the second transmission path R2.

In the embodiment, the processor 120 first uses the first control signal Sc1 of the first logic level to control the first switching line 136 and the second switching line 138 to transmit the transmission signal St through the first transmission path R1, so that the first redriver 132 located on the first transmission path R1 is caused to re-drive the transmission signal St. When the processor 120 evaluates that the transmission signal amount of the transmission signal St is less than the first threshold percentage in a case where the transmission signal St is transmitted through the first transmission path R1, the processor 120 may use the first control signal Sc1 of the second logic level to control the first switching line 136 and the second switching line 138 to switch to transmitting the transmission signal St through the second transmission path R2, so that the first serialization and deserialization circuit 134 located on the second transmission path R2 is caused to perform parallel-to-serial conversion on the transmission signal St.

In more detail, each of the first switching line 136 and the second switching line 138 has a first path end T1, a second path end T2, a third path end T3, and a switching control end TC. As shown in FIG. 2, the first path end T1 of the first switching line 136 is coupled to the processor 120, the second path end T2 of the first switching line 136 is coupled to one end of the first transmission path R1, and the third path end T3 of the first switching line 136 is coupled to one end of the second transmission path R2. The first path end T1 of the second switching line 138 is coupled to the first transmission interface 112, the second path end T2 of the second switching line 138 is coupled to the other end of the first transmission path R1, and the third path end T3 of the second switching line 138 is coupled to the other end of the second transmission path R2. The switching control ends TC of the first switching line 136 and the second switching line 138 receive the first control signal Sc1.

When the first control signal Sc1 is at the first logic level, the first switching line 136 and the second switching line 138 respectively switch the first path end T1 to be coupled to the corresponding second path end T2. In this way, the transmission signal St may be transmitted through the first transmission path R1 in the first modulation circuit 130, and at the same time, the transmission signal St may be redriven through the first redriver 132.

When the first control signal Sc1 is at the second logic level, the first switching line 136 and the second switching line 138 respectively switch the first path end T1 to be coupled to the corresponding third path end T3. In this way, the transmission signal St may be transmitted through the second transmission path R2 in the first modulation circuit 130, and at the same time, the transmission signal St may be converted from serial to parallel through the first serialization and deserialization circuit 134.

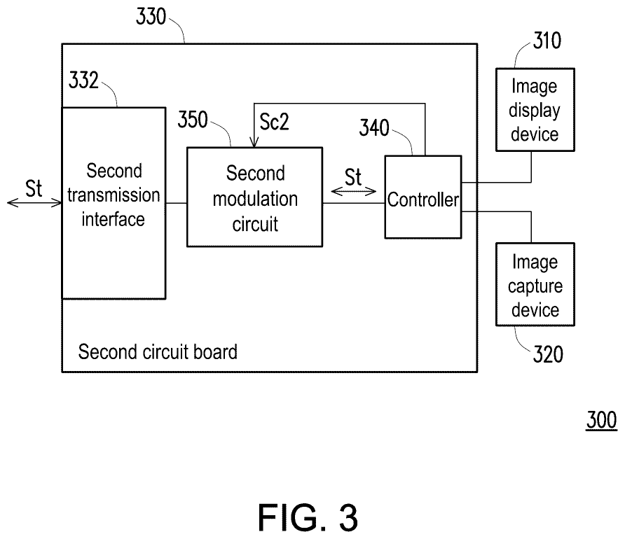

Referring to FIG. 3, an imaging device 300 of the embodiment includes an image display device 310, an image capture device 320, a second circuit board 330, a controller 340, and a second modulation circuit 350.

The image display device 310 is, for example, a display using a liquid crystal display (LCD), a light-emitting diode (LED), a field emission display (FED), or other types of panels. The image display device 310 may display images according to the transmission signal St received by the imaging device 300 from the outside.

The image capture device 320 is, for example, a device including an optical fixed focus lens or an optical zoom lens, and a photosensitive element such as a charge coupled device (CCD) or a complementary metal-oxide semiconductor (CMOS) device. The image captured by the image capture device 320 may be converted into the transmission signal St and output to the outside.

The second circuit board 330 is also implemented by a printed circuit board, for example. The second circuit board 330 has a second transmission interface 332, which may transmit signals with external devices through connected cables. Compared with the first circuit board 110 in the above embodiment, the second circuit board 330 is smaller in area and scale, and has fewer parts installed thereon.

The controller 340 is, for example, a programmable chip such as a microcontroller. The controller 340 is mounted on the second circuit board 330 and coupled to the image display device 310 and the image capture device 320. The controller 340 may evaluate the transmission quality of the transmission signal St transmitted (including output or received) through the second transmission interface 332.

The second modulation circuit 350 is mounted on the second circuit board 330 and coupled between the controller 340 and the second transmission interface 332.

In the example, the controller 340 may transmit a second control signal Sc2 to the second modulation circuit 350 according to the evaluated transmission quality of the transmission signal St, so as to switch the modulation mode of the transmission signal St performed by the second modulation circuit 350. For example, when the second control signal Sc2 is at a first logic level (e.g., a high logic level), the second modulation circuit 350 re-drives the transmission signal St. When the second control signal Sc2 is at a second logic level (e.g., a low logic level), the second modulation circuit 350 performs parallel-to-serial conversion on the transmission signal St.

Furthermore, the transmission quality of the transmission signal St includes the transmission signal amount of the transmission signal St. The controller 340 may evaluate the transmission signal amount of the transmission signal St output to or received from the outside through the second transmission interface 332. In the embodiment, the initial value of the second control signal Sc2 output by the controller 340 is the first logic level. That is to say, the second modulation circuit 350 first modulates the transmission signal St in a re-driving mode to reshape the transmission signal St. In addition to increasing the gain, the waveform may also be restored as much as possible.

When the controller 340 evaluates that the transmission signal amount of the redriven transmission signal St is less than a first threshold percentage (e.g., about sixty percent), it means that even if re-driving has been performed, the transmission signal St is still attenuated too much after transmission, and the waveform becomes incomplete, possibly because the cable used for signal transmission with an external device is long or is subject to external electromagnetic wave interference. At this time, the controller 340 may transmit the second control signal Sc2 of the second logic level to the second modulation circuit 350 to control the second modulation circuit 350 to perform parallel-to-serial conversion on the transmission signal St. In this way, the second modulation circuit 350 may modulate the transmission signal St in a parallel-to-serial conversion mode. When outputting the transmission signal St to an external device, the second modulation circuit 350 may convert the transmission signal St into an ultra-high-speed serial form for transmission on the cable. When receiving the transmission signal St from an external device, the second modulation circuit 350 may convert the transmission signal St from an ultra-high-speed serial form to an original form (e.g., a parallel form). In this way, the data processing capacity of the signal per unit time may be increased, and the signal is less susceptible to external interference when transmitted through cables, thus improving the transmission quality.

On the other hand, when the controller 340 evaluates that the transmission signal amount of the transmission signal St is at or above the first threshold percentage, it means that the current transmission signal St still meets the transmission standard. At this time, the controller 340 may continue to transmit the second control signal Sc2 of the first logic level to the second modulation circuit 350, so that the second modulation circuit 350 continues to re-drive the transmission signal St.

Furthermore, in an embodiment, when the data rate of the redriven transmission signal St is more than the second threshold percentage (e.g., about 80 percent), it means that the demand for data processing capacity is higher. At this time, the controller 340 may also switch from the re-driving mode to the parallel-to-serial conversion mode to modulate the transmission signal St, so as to increase the data processing capacity of the signal per unit time.

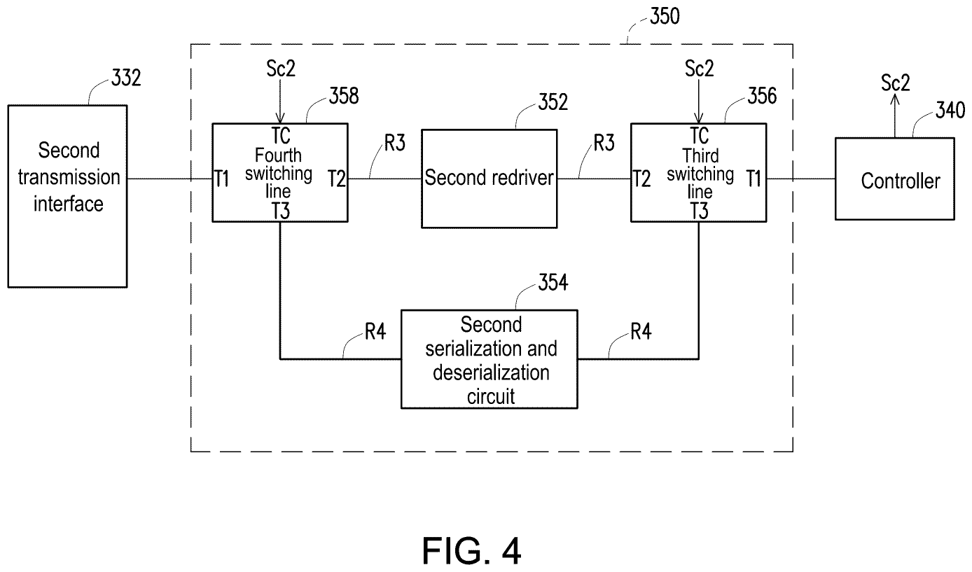

The following examples illustrate the implementation details of the second modulation circuit 350. Referring to FIG. 4, the second modulation circuit 350 includes a third transmission path R3, a fourth transmission path R4, a second redriver 352, a second serialization and deserialization circuit 354, a third switching line 356, and a fourth switching line 358.

The second redriver 352 is located on the third transmission path R3 and may re-drive the transmission signal St transmitted on the third transmission path R3.

The second serialization and deserialization circuit 354 is implemented, for example, as a combination of a serializer and a de-serializer. The second serialization and deserialization circuit 354 is located on the fourth transmission path R4 and may perform parallel-to-serial conversion on the transmission signal St transmitted on the fourth transmission path R4. For example, when receiving the transmission signal St from the controller 340 side, the second serialization and deserialization circuit 354 may convert the transmission signal St into an ultra-high-speed serial form through the function of the serializer and provide the same to the second transmission interface 332. When receiving the transmission signal St from the second transmission interface 332 side, the second serialization and deserialization circuit 354 may convert the transmission signal St from an ultra-high-speed serial form to an original form (e.g., a parallel form) through the function of the de-serializer.

The third switching line 356 is coupled to the controller 340, one end of the third transmission path R3, and one end of the fourth transmission path R4. The third switching line 356 may be controlled by the second control signal Sc2 such that the controller 340 is caused to switch between being coupled to the third transmission path R3 and being coupled to the fourth transmission path R4.

The fourth switching line 358 is coupled to the second transmission interface 332, the other end of the third transmission path R3, and the other end of the fourth transmission path R4. The fourth switching line 358 may be controlled by the second control signal Sc2 such that the second transmission interface 332 is caused to switch between being coupled to the third transmission path R3 and being coupled to the fourth transmission path R4.

In the embodiment, the controller 340 first uses the second control signal Sc2 of the first logic level to control the third switching line 356 and the fourth switching line 358 to transmit the transmission signal St through the third transmission path R3, so that the second redriver 352 located on the third transmission path R3 is caused to re-drive the transmission signal St. When the controller 340 evaluates that the transmission signal amount of the transmission signal St is less than the first threshold percentage in a case where the transmission signal St is transmitted through the third transmission path R3, the controller 340 may use the second control signal Sc2 of the second logic level to control the third switching line 356 and the fourth switching line 358 to switch to transmitting the transmission signal St through the fourth transmission path R4, so that the second serialization and deserialization circuit 354 located on the fourth transmission path R4 is caused to perform parallel-to-serial conversion on the transmission signal St.

In more detail, each of the third switching line 356 and the fourth switching line 358 has a first path end T1, a second path end T2, a third path end T3, and a switching control end TC. As shown in FIG. 4, the first path end T1 of the third switching line 356 is coupled to the controller 340, the second path end T2 of the third switching line 356 is coupled to one end of the third transmission path R3, and the third path end T3 of the third switching line 356 is coupled to one end of the fourth transmission path R4. The first path end T1 of the fourth switching line 358 is coupled to the second transmission interface 332, the second path end T2 of the fourth switching line 358 is coupled to the other end of the third transmission path R3, and the third path end T3 of the fourth switching line 358 is coupled to the other end of the fourth transmission path R4. The switching control ends TC of the third switching line 356 and the fourth switching line 358 receive the second control signal Sc2.

When the second control signal Sc2 is at the first logic level, the third switching line 356 and the fourth switching line 358 respectively switch the first path end T1 to be coupled to the corresponding second path end T2. In this way, the transmission signal St may be transmitted through the third transmission path R3 in the second modulation circuit 350, and at the same time, the transmission signal St may be redriven through the second redriver 352.

When the second control signal Sc2 is at the second logic level, the third switching line 356 and the fourth switching line 358 respectively switch the first path end T1 to be coupled to the corresponding third path end T3. In this way, the transmission signal St may be transmitted through the fourth transmission path R4 in the second modulation circuit 350, and the transmission signal St may be converted from serial to parallel through the second serialization and deserialization circuit 354.

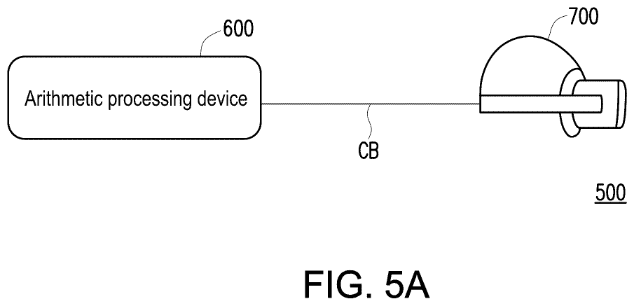

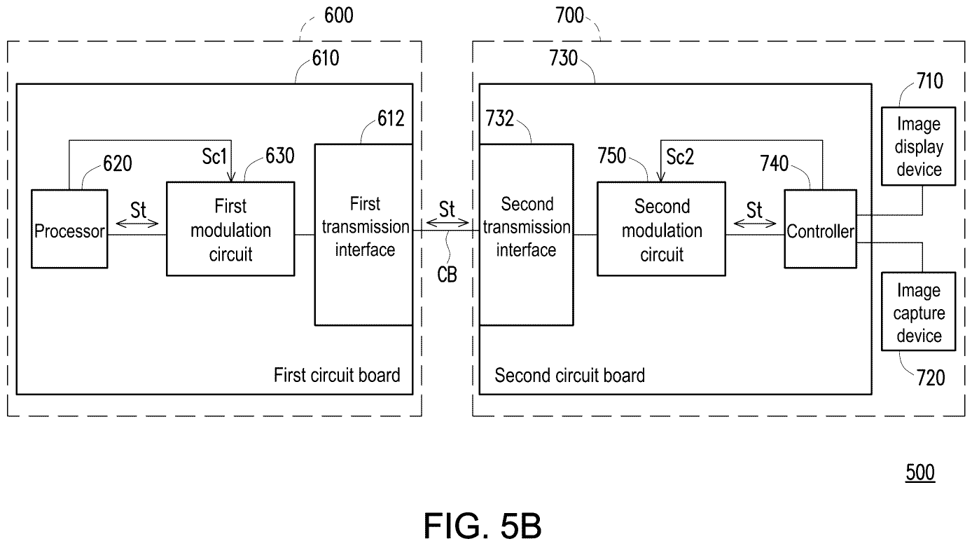

Referring to FIG. 5A and FIG. 5B at the same time, a two-section head mounted system 500 of the embodiment includes an arithmetic processing device 600 and an imaging device 700. The arithmetic processing device 600 includes a first circuit board 610 with a first transmission interface 612, a processor 620, and a first modulation circuit 630. The imaging device 700 includes an image display device 710, an image capture device 720, and a second circuit board 730 with a second transmission interface 732, a controller 740, and a second modulation circuit 750. The arithmetic processing device 600 mainly serves as the signal and data processing center of the head mounted system 500. The internal circuit is more complex and may include heavy components such as batteries and memory (such as hard disks), and the arithmetic processing device 600 may be worn on other parts of the body other than the user's head, such as being carried on the user's back or strapped to the user's body. The imaging device 700 is mainly responsible for displaying and capturing images in front of the user's eyes, and may include various sensors. The internal circuit is relatively simple. Since the imaging device 700 needs to be worn on the user's head during use, it should be as lightweight as possible.

The second transmission interface 732 in the imaging device 700 and the first transmission interface 612 in the arithmetic processing device 600 may be detachably connected to each other through a cable CB. The transmission signal St may be transmitted between the arithmetic processing device 600 and the imaging device 700 through the cable CB.

In the embodiment, the processor 620 in the arithmetic processing device 600 and the controller 740 in the imaging device 700 may work together to complete an evaluation of the transmission quality of the transmission signal St transmitted through the first transmission interface 612 and the second transmission interface 732, so as to respectively switch the modulation mode of the transmission signal St performed by the first modulation circuit 630 and the second modulation circuit 750. For example, when the transmission signal St is transmitted from the arithmetic processing device 600 to the imaging device 700, the controller 740 may evaluate the transmission signal amount of the received transmission signal St, and transmit relevant information of the evaluation result to the processor 620. Similarly, when the transmission signal St is transmitted from the imaging device 700 to the arithmetic processing device 600, the processor 620 may evaluate the transmission signal amount of the received transmission signal St, and transmit relevant information of the evaluation result to the controller 740.

In the embodiment, the initial value of the first control signal Sc1 output by the processor 620 and the initial value of the second control signal Sc2 output by the controller 740 are both at the first logic level. That is to say, the first modulation circuit 630 and the second modulation circuit 750 first modulate the transmission signal St in a re-driving mode. When it is evaluated that the amount of the redriven transmission signal is less than the first threshold percentage (for example, about 60%), it means that even if re-driving has been performed, the attenuation of the transmission signal St is still too large after transmission, and the waveform becomes incomplete. At this time, the processor 620 may transmit the first control signal Sc1 of the second logic level to the first modulation circuit 630, and the controller 740 may transmit the second control signal Sc2 of the second logic level to the second modulation circuit 750, so as to respectively control the first modulation circuit 630 and the second modulation circuit 750 to perform parallel-to-serial conversion on the transmission signal St. In this way, the first modulation circuit 630 and the second modulation circuit 750 may modulate the transmission signal St in a parallel-to-serial conversion mode. In this way, the data processing capacity of the signal per unit time may be increased, and the signal is less susceptible to external interference when transmitted through cables, thus improving the transmission quality.

Furthermore, in an embodiment, when the data rate of the redriven transmission signal St is more than the second threshold percentage (e.g., about 80 percent), it means that the demand for data processing capacity is higher. At this time, the processor 620 and the controller 740 may also switch from the re-driving mode to the parallel-to-serial conversion mode to modulate the transmission signal St, so as to increase the data processing capacity of the signal per unit time.

The coupling method, function and operation method of each component in the arithmetic processing device 600 and the imaging device 700 are the same as or similar to the coupling method, function and operation method of each component in the arithmetic processing device 100 and the imaging device 300 in the above embodiment, and therefore is not repeated herein.

In summary, the arithmetic processing device, imaging device and head mounted system of the disclosure may independently configure various components required for the head mounted display on different hardware structures, and may dynamically switch the modulation mode of the transmission signal according to the current transmission quality. In this way, these components are no longer limited to the parts arranged in the head mounted structure, which may reduce the weight originally placed on the user's head. In addition, there is no need to worry about the transmission quality being affected by long cable lengths between hardware structures or interference from external electromagnetic waves. Not only can it extend the use time and avoid shoulder and neck pain, but it can also arbitrarily change the length or style of the cable according to the position of the arithmetic processing device on the user's body, thus giving the user a better use experience.

What is claimed is:

1. An arithmetic processing device, comprising:
a first circuit board, having a first transmission interface;
a processor, mounted on the first circuit board, and configured to evaluate transmission quality of a transmission signal transmitted through the first transmission interface; and
a first modulation circuit, mounted on the first circuit board, and coupled between the processor and the first transmission interface,
wherein the processor transmits a first control signal to the first modulation circuit according to the evaluated transmission quality of the transmission signal, so as to switch a modulation mode of the transmission signal performed by the first modulation circuit.

2. The arithmetic processing device according to claim 1, wherein when the first control signal is at a first logic level, the first modulation circuit re-drives the transmission signal, and when the first control signal is at a second logic level, the first modulation circuit performs parallel-to-serial conversion on the transmission signal.

3. The arithmetic processing device according to claim 1, wherein the first modulation circuit comprises:
a first transmission path;
a second transmission path;
a first redriver, located on the first transmission path, and configured to re-drive the transmission signal transmitted on the first transmission path:
a first serialization and deserialization circuit, located on the second transmission path, and configured to perform parallel-to-serial conversion on the transmission signal transmitted on the second transmission path;
a first switching line, coupled to the processor, the first transmission path, and the second transmission path, and configured to be controlled by the first control signal such that the processor is caused to switch between being coupled to the first transmission path and being coupled to the second transmission path; and
a second switching line, coupled to the first transmission interface, the first transmission path, and the second transmission path, and configured to be controlled by the first control signal such that the first transmission interface is caused to switch between being coupled to the first transmission path and being coupled to the second transmission path.

4. The arithmetic processing device according to claim 3, wherein the transmission quality comprises a transmission signal amount of the transmission signal, and when the processor evaluates that the transmission signal amount of the transmission signal is less than a first threshold percentage in a case where the transmission signal is transmitted through the first transmission path, the processor uses the first control signal to control the first switching line and the second switching line to switch to transmitting the transmission signal through the second transmission path.

5. The arithmetic processing device according to claim 3, wherein when the processor evaluates that a data rate of the transmission signal is more than a second threshold percentage in a case where the transmission signal is transmitted through the first transmission path, the processor uses the first control signal to control the first switching line and the second switching line to switch to transmitting the transmission signal through the second transmission path.

6. The arithmetic processing device according to claim 3, wherein each of the first switching line and the second switching line has a first path end, a second path end, a third path end, and a switching control end, the first path end of the first switching line is coupled to the processor, the second path end of the first switching line is coupled to one end of the first transmission path, the third path end of the first switching line is coupled to one end of the second transmission path, the first path end of the second switching line is coupled to the first transmission interface, the second path end of the second switching line is coupled to the other end of the first transmission path, the third path end of the second switching line is coupled to the other end of the second transmission path, and the switching control ends of the first switching line and the second switching line receive the first control signal.

7. The arithmetic processing device according to claim 6, wherein when the first control signal is at a first logic level, the first switching line and the second switching line respectively switch the first path end to be coupled to the corresponding second path end, and when the first control signal is at a second logic level, the first switching line and the second switching line respectively switch the first path end to be coupled to the corresponding third path end.

8. An imaging device, comprising:
an image display device;
an image capture device;
a second circuit board, having a second transmission interface;
a controller, mounted on the second circuit board and coupled to the image display device and the image capture device, and configured to evaluate transmission quality of a transmission signal transmitted through the second transmission interface; and
a second modulation circuit, mounted on the second circuit board, and coupled between the controller and the second transmission interface,
wherein the controller transmits a second control signal to the second modulation circuit according to the evaluated transmission quality of the transmission signal, so as to switch a modulation mode of the transmission signal performed by the second modulation circuit.

9. The imaging device according to claim 8, wherein when the second control signal is at a first logic level, the second modulation circuit re-drives the transmission signal, and when the second control signal is at a second logic level, the second modulation circuit performs parallel-to-serial conversion on the transmission signal.

10. The imaging device according to claim 8, wherein the second modulation circuit comprises:
a third transmission path;
a fourth transmission path;
a second redriver, located on the third transmission path, and configured to re-drive the transmission signal transmitted on the third transmission path:
a second serialization and deserialization circuit, located on the fourth transmission path, and configured to perform parallel-to-serial conversion on the transmission signal transmitted on the fourth transmission path;
a third switching line, coupled to the controller, the third transmission path, and the fourth transmission path, and configured to be controlled by the second control signal such that the controller is caused to switch between being coupled to the third transmission path and being coupled to the fourth transmission path; and
a fourth switching line, coupled to the second transmission interface, the third transmission path, and the fourth transmission path, and configured to be controlled by the second control signal such that the second transmission interface is caused to switch between being coupled to the third transmission path and being coupled to the fourth transmission path.

11. The imaging device according to claim 10, wherein the transmission quality comprises a transmission signal amount of the transmission signal, when the controller evaluates that the transmission signal amount of the transmission signal is less than a first threshold percentage in a case where the transmission signal is transmitted through the third transmission path, the controller uses the second control signal to control the third switching line and the fourth switching line to switch to transmitting the transmission signal through the fourth transmission path.

12. The imaging device according to claim 10, wherein when the controller evaluates that a data rate of the transmission signal is more than a second threshold percentage in a case where the transmission signal is transmitted through the third transmission path, the controller uses the second control signal to control the third switching line and the fourth switching line to switch to transmitting the transmission signal through the fourth transmission path.

13. The imaging device according to claim 10, wherein each of the third switching line and the fourth switching line has a first path end, a second path end, a third path end, and a switching control end, the first path end of the third switching line is coupled to the controller, the second path end of the third switching line is coupled to one end of the third transmission path, the third path end of the third switching line is coupled to one end of the fourth transmission path, the first path end of the fourth switching line is coupled to the second transmission interface, the second path end of the fourth switching line is coupled to the other end of the third transmission path, the third path end of the fourth switching line is coupled to the other end of the fourth transmission path, and the switching control ends of the third switching line and the fourth switching line receive the second control signal.

14. The imaging device according to claim 13, wherein when the second control signal is at a first logic level, the third switching line and the fourth switching line respectively switch the first path end to be coupled to the corresponding second path end, and when the second control signal is at a second logic level, the third switching line and the fourth switching line respectively switch the first path end to be coupled to the corresponding third path end.

15. A head mounted system, comprising:
an arithmetic processing device, comprising:
a first circuit board, having a first transmission interface;
a processor, mounted on the first circuit board; and
a first modulation circuit, mounted on the first circuit board, and coupled between the processor and the first transmission interface; and
an imaging device, comprising:
an image display device and an image capture device;
a second circuit board, having a second transmission interface, wherein the second transmission interface and the first transmission interface are detachably connected to each other through a cable;
a controller, mounted on the second circuit board, and coupled to the image display device and the image capture device; and
a second modulation circuit, mounted on the second circuit board, and coupled between the controller and the second transmission interface,
wherein the processor and the controller work together to complete an evaluation of transmission quality of a transmission signal transmitted through the first transmission interface and the second transmission interface, so as to respectively switch a modulation mode of the transmission signal performed by the first modulation circuit and the second modulation circuit.
